(19) United States
(12) Patent Application Publication
(10) Pub. No.: US 2015/0066766 A1
(43) Pub. Date: Mar. 5, 2015

(54) Secure Generation of a User Account in a Service Server

(71) Applicant: Deutsche Post AG, Bonn (DE)

(72) Inventors: Andre Wittenburg, Berlin (DE); Mike Bobinski, Bonn (DE)

(73) Assignee: Deutsche Post AG, Bonn (DE)

(21) Appl. No.: 14/391,907

(22) PCT Filed: Apr. 4, 2013
(86) PCT No.: PCT/EP2013/057098

§ 371 Date: Oct. 10, 2014

(30) Foreign Application Priority Data
Apr. 11, 2012 (DE) 102012205904.0

(51) Int. Cl. G06Q 20/38; G06Q 20/02; G06Q 20/40

(52) U.S. Cl. CPC G06Q 20/383; G06Q 20/4014; G06Q 20/02
USPC 705/44; 705/39

(57) ABSTRACT

A method for providing user identification data in order to generate a user account containing user identification data in a service server that provides an electronic service, makes use of a user account. The user is registered in an intermediary agency and, on the basis of the registration of the user, the intermediary agency transmits to the service server, the user identification data as well as a request for the generation of the user account. This is done in such a way that the service server generates the user account, making use of the user identification data. The intermediary agency can serve as a trusted web platform for users and service providers, and can allow users to access services anonymously. The subject innovation also relates to an intermediary agency that is suitable to carry out the method, and it also relates to a computer program for carrying out the method.

### CROSS-REFERENCE TO RELATED APPLICATIONS

Pursuant to 35 U.S.C. §371, this application is the United States National Stage Application of International Patent Application No. PCT/EP2013/057098, filed on Apr. 4, 2013, the contents of which are incorporated by reference as if set forth in their entirety herein, which claims priority to German (DE) Patent Application No. 102012205904.0, filed Apr. 11, 2012, the contents of which are incorporated by reference as if set forth in their entirety herein.

### BACKGROUND

In order to access electronic services that are provided via web platforms or in a comparable manner, users often register with the service provider that is offering these services. With fee-based services, registration enables the service provider to invoice the user for the fees incurred for use of the service. As a rule, the registration involves supplying personal data of the user such as, for example, the name and address of the user as well as information such as, for instance, credit card data and/or bank account data, so that the user can be invoiced for the fees incurred.

However, many users are hesitant to reveal their personal data. They are afraid of a loss of privacy and that the personal data they have supplied will be fraudulently used by the service provider or by third parties that might gain unauthorized access to the data stored by the service provider. As a result, users find registration with a service server to be unpleasant, or else they even completely avoid the use of services involving a registration that requires them to provide personal data.

### SUMMARY

The subject innovation relates to the generation of a user account with a provider of an electronic service. The subject innovation also relates to a method, and to an intermediary agency for providing user identification data in order to generate a user account containing user identification data in a service server that provides an electronic service, making use of a user account.

According to a first aspect, the subject innovation puts forward a method for providing user identification data in order to generate a user account containing user identification data in a service server that provides an electronic service, making use of the user account. The user is registered with personal data in an intermediary agency and, on the basis of the registration of the user, the intermediary agency transmits to the service server the user identification data as well as a request for the generation of the user account, and this is done in such a way that the service server generates the user account, making use of the user identification data.

According to another aspect of the subject innovation, an intermediary agency for providing user identification data in order to generate a user account containing user identification data in a service server is being put forward that provides an electronic service, making use of the user account. The intermediary agency involves registration of the user with personal data of the user and, on the basis of the registration of the user, it is configured to transmit to the service server the user identification data as well as a request for the generation of the user account, and this is done in such a way that the service server generates the user account, making use of the user identification data.

The user identification data that is transferred from the intermediary agency to the service server does not contain the personal data with which the user is registered in the intermediary agency. One advantage of the envisaged generation of the user account via the intermediary agency lies in the fact that the personal data of the user is not transmitted to the service server or to the service provider operating the service server. The service provider can trust that the data is stored correctly in the intermediary agency so that, for example, invoicing procedures for fee-based services can be carried out securely and reliably. Here, the intermediary agency serves as a trusted entity vis-à-vis the service provider.

In one embodiment of the method and of the intermediary agency, it is provided that the user identification data comprises a user identifier generated autonomously by the intermediary agency and/or a user identifier indicated by the user. The user identifier is unambiguously associated with the user. On the basis of the user identifier, an unambiguous relationship is advantageously established between the user account of the user in the service server and the registration of the user in the intermediary agency.

In another embodiment of the method and of the intermediary agency, the user identification data comprises an authentication feature indicated by the user which, in particular, can be a secret password of the user. The authentication feature can be contained in the user identification data in addition to the user identifier.

One embodiment of the method and of the intermediary agency is characterized in that, after the user account has been generated, the service is accessed on the basis of the user identification data. Consequently, via the intermediary agency, a user account is advantageously generated which can be accessed later on the basis of the user identification data that is provided by the intermediary agency so that the service provided by the service server can be utilized.

One embodiment of the method and of the intermediary agency comprises that the user identification data is transmitted by the user to the service server so that the service can be accessed. In this embodiment, the user can advantageously access the service server directly, that is to say, without having to involve the intermediary agency himself. In order for the user identification data to be transmitted, this data can be entered, for example, by the user on a website provided by the service server.

In an associated embodiment, the service server compares the transmitted user identification data to the user identification data stored in the user account and, after a successful comparison, the service server allows access to the service. In order to ensure secure access to the service, in this embodiment, the user identification data comprises the user identifier as well as an authentication feature of the user.

Another associated embodiment of the method and of the intermediary agency provides that the service server transmits to the intermediary agency the user identification data that had been transmitted by the user so that it can be checked, and the service server then grants access to the service by the user on the basis of having received a confirmation message from the intermediary agency about the successful checking of the user identification data. In this embodiment, the service server advantageously makes use of the intermediary agency in order to check the user identification data. In this embodiment, the user identification data can be merely the user identifier. In this case, a high level of security can be achieved by involving the intermediary agency.

In another embodiment of the method and of the intermediary agency, the user identification data is transmitted by the intermediary agency to the service server in response to a request to this effect by the user so that the service can be accessed. In this embodiment, the user does not transmit the user identification data to the service server himself, but rather can utilize the intermediary agency for this purpose. In particular, the intermediary agency can provide a website where the request can be made by the user.

In order to allow secure access to the service, in an associated embodiment of the method and of the intermediary agency, the user identification data is transmitted to the service server together with an authentication feature of the intermediary agency, and the service server grants access to the service by the user after the checking of the authentication feature has been successful. The authentication feature can be, for instance, a digital signature generated by the intermediary agency.

In an embodiment of the method and of the intermediary agency, it is provided that the intermediary agency carries out an authentication of the user and that the user identification data is only transmitted to the service server after the successful authentication of the user. In this manner, it is ensured that the intermediary agency cannot be used by an unauthorized third party to generate a user account for the user in a service server.

Furthermore, one embodiment of the method and of the intermediary agency provides that the intermediary agency makes a payment on behalf of the user in response to having received a payment request from the service server. This lends itself especially well for the payment of fees that are incurred because of a certain user action. For regularly recurring costs such as, for instance, basic fees that are paid regularly at prescribed invoicing intervals, in another embodiment, the invoicing can also be carried out automatically by the intermediary agency. For this purpose, the amount of the fees and the points in time for the invoicing can be stored in the intermediary agency.

The payment for the use of a fee-based service can thus be made via the intermediary agency. This has the advantage that sensitive data of the user that is used to make the payment is not provided to the service server. After the payment has been made, invoicing is carried out between the intermediary agency or its operator and the service provider so that the amount to be paid for the use of the service can be forwarded to the service provider.

An associated embodiment of the method and of the intermediary agency is characterized in that, in order to make the payment, the user is redirected from the service server to the intermediary agency. The invoice is transmitted in conjunction with the redirection from the service server to the intermediary agency.

Aside from the method and the intermediary agency, the subject innovation also puts forward a computer program. The computer program comprises instructions for carrying out the method by a processor unit when the computer program is executed on the processor unit.

### BRIEF DESCRIPTION OF THE DRAWINGS

The above-mentioned and additional advantages, special features and advantageous refinements are also elucidated on the basis of the embodiments that are described below with reference to the figures.

The figures show the following:

FIG. 1 is a schematic depiction of a system having a service server of a service provider, a user and an intermediary agency; and

FIG. 2 is a schematic depiction of steps for carrying out a mobile TAN method.

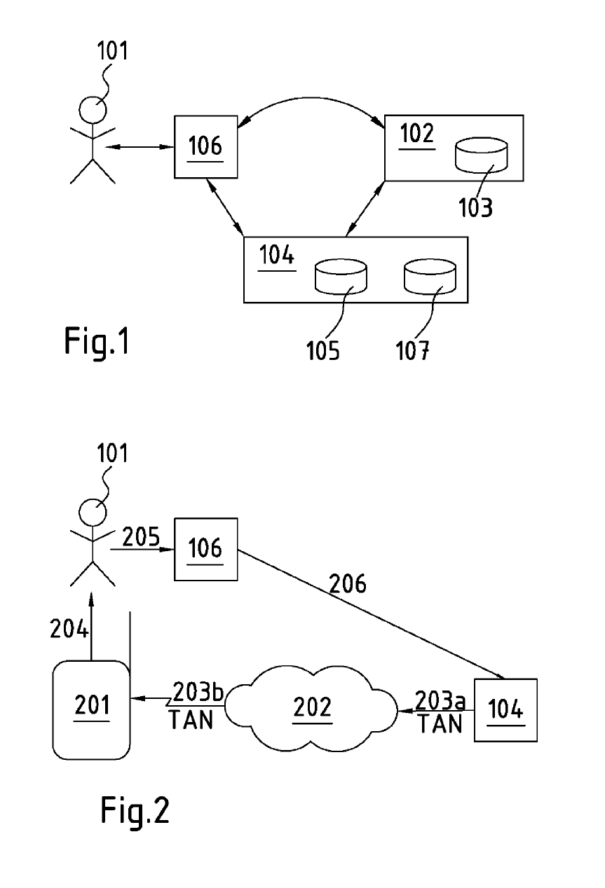

In the arrangement that is shown schematically in FIG. 1, users 101 (a single one of whom is shown in the figure by way of an example) can access a service that is provided by a service server 102 of a service provider. The service server 102 is accessed via a data network (not shown in the figure) such as, for example, the Internet, which permits an electronic exchange of data with the service server 102. The service server 102 provides the service via a web platform (website) that can comprise one or more individual web pages via which the user 101 can interact with the service server 102. The service offered by the service server 102 can be any service that is generally known to the person skilled in the art and that can be made accessible via a web platform. Examples are an e-commerce service for the purchase of electronic contents, a social network service and an online banking service. The service server 102 is configured in a manner that is generally known to the person skilled in the art, such as, as a server computer that has one or more processors for executing software that provides the web platform. The service server 102 also has a memory unit for storing the software as well as additional data and, if necessary, other components to provide the web platform.

To access the service provided by the service server, the user 101 registers in the service server 102. For purposes of the registration, a user account associated with the user 101 is generated in a user database 103 of the service server 102. The user database 103 is contained in the memory unit of the service server 102. After a user account has been generated for a user 101 in the service server 102, the user 101 can use his user account 102 to access the service offered by the service server 102 so as to use the service.

In the arrangement shown, the user accounts can be set up by an intermediary agency 104, whereby the intermediary agency 104 provides user identification data that is to be stored in the user accounts that have been set up. However, by the same token, it can also be provided that users 101 register in the service server 102 directly, that is to say, without the involvement of the intermediary agency 104. In the case of such a registration of a user 101, personal data of the user 101 is acquired and stored within the user account that has been generated for the user 101 in the user database 103 of the service server 102. In one embodiment, the personal user data comprises information to unambiguously identify the user 101 so that the service provider acquires unambiguous knowledge about the identity of the user 101. This information, which can comprise, for example, the name of the user 101 and, if applicable, additional information such as his date of birth, can be used by the service provider, among other things, to request compensation, such as, monetary compensation from the user 101 for use of the service. Moreover, additional user data can also be acquired such as a mailing address of the user 101, phone numbers and/or addresses for electronic communication, for example, e-mail addresses.

Aside from the personal data of the user 101, identification and authentication information is stored in a user account of the service server 102, and this information is used to identify and to authenticate the user 101 when logging in to the service server 102 in order to access the service. In one embodiment, a user identifier is stored in the user account as the identification feature. The user identifier is unambiguously associated with the user and can be indicated by the user when the user account is set up. In one embodiment, a secret password is used as the authentication feature, which the user 101 can choose. When the user 101 logs in to the service server 102, he is prompted by a website provided on the service server 102 to enter his identification and authentication features. The entries of the user 101 are transmitted to the service server 102 via the website and these entries are checked by the service server 102 which compares the entered identification and authentication features to the corresponding data that is stored in the user account of the user 101. Access to the services provided by the service server 102 is allowed if the checking of the identification and authentication features has been successful.

The intermediary agency 104 for the automated generation of user accounts is configured as another server computer that is connected to the service server 102 via the data network. For the data exchange with the service server 102, the intermediary agency 104 provides interfaces for electronic communication which permit an automated data exchange without the involvement of an operator of the intermediary agency 104 and of the service server 102. The communication between the intermediary agency 104 and the service server 102 is secured against unauthorized manipulations by third parties, and this is done through suitable mechanisms that are generally known to the person skilled in the art, such as, cryptographic mechanisms. In order to perform the envisaged functions, the intermediary agency 104 has hardware that comprises one or more processors, a memory unit as well as, if applicable, additional hardware components for implementing the functions of the intermediary agency 104.

Although FIG. 1 shows only one single service server 102, the intermediary agency 104 is capable of interacting with a plurality of service servers 102 that can offer different services and/or that can be operated by different service providers. The service providers and the service server 102 they operate as well as the services provided by the service servers 102 are registered in the intermediary agency 104. For this purpose, the intermediary agency 104 makes a database 105 available in which the data for the service server 102 and for the service provider are stored.

The data stored for the service server 102 in the service database 105 includes information for the identification of the service server 102 and for the authentication of the service server 102 in the intermediary agency 104. In one embodiment, the authentication is carried out on the basis of cryptographic methods and information generally known to the person skilled in the art, such as, cryptographic keys that are executed or stored in the intermediary agency 104. For the service servers 102 registered in the service database 105, each of the provided services is registered on the basis of information that is displayed to users 101 in order to inform them about the type and content of the services and in order to allow the users to choose a service. This information includes a description of the contents of the services provided as well as the prices and other conditions for using the services. Regarding the service providers, information for the identification of the service provider is stored in the service database 105, said information allowing users 101 to place requests with the service providers pertaining to the provision of the services.

In one embodiment, the information stored in the service database 105 is acquired and checked by the operator of the intermediary agency 104 in a secure process. In addition, it can be stipulated that a service provider or a service provided by a service provider is registered in the intermediary agency 104 if it meets prescribed selection criteria that can be specified by the operator of the intermediary agency 104. The secure acquisition of the information stored in the service database 105 and the suitable selection criteria can ensure that registration in the intermediary agency 104 is limited to reputable service providers and services. Thanks to these measures, the intermediary agency 104 acquires the status of a trusted entity vis-à-vis the users 101, without an additional verification.

In the system shown in FIG. 1, the user 101 employs a user computer 106 to access the intermediary agency 104 and, if applicable, to directly access the service server 102. The intermediary agency 104 is likewise accessed via the data network (not shown in the figure). The user computer 106 is a stationary or mobile data processing system that is equipped with a processor unit as well as with a memory unit and that, for interaction with the user 101, has a user interface with input and output means that are generally known to the person skilled in the art. For purposes of interaction with the user 101, the intermediary agency 104 likewise provides a web platform with one or more web pages. For purposes of accessing the web platform by the user computer 106, the user computer 106 has a generally known web browser. This is a software program that is installed on the user computer 106 and that can be executed by the processor unit, thereby allowing the user 101 to see websites and to interact with appropriate elements of websites such as, for example, input fields and buttons. Examples of web browsers that can be used in the user computer 106 are the programs “Internet Explorer” of the Microsoft corporation and “Firefox” of the Mozilla Foundation.

Users 101 who would like to set up a user account with the service server 102 via the intermediary agency 104 are registered in the intermediary agency 104. During the registration, user data about the users 101 is stored in a user database 107 of the intermediary agency 104. The user data includes at least the above-mentioned information that is stored in the user account of the user database 103 of the service server 102, even when a user registers directly in the service server 102.

The intermediary agency 104 plays the role of a trusted entity vis-à-vis the service server 102 or the service provider. This means that the service provider trusts the correctness of the user data that is stored in the intermediary agency 104. For this purpose, the operator of the intermediary agency 104 ensures that the user data stored in the user database 107 is correct. Towards this end, the user data is acquired by the operator in a secure process.

The user data indicated by a user 101 is checked by the operator by checking the documentation submitted or in some other manner. In one embodiment, the user 101 appears in person at the operator's premises so that the user data can be acquired. In this process, the user 101 presents identity documents and, if applicable, additional reliable documentation to substantiate his information, and then an employee of the operator checks the identity documents before the user data contained in the identity documents is stored in the identity database 101. User data that cannot be substantiated on the basis of identity documents, certificates or similar documentation can be checked in some other manner. Addresses such as, for example, e-mail addresses or phone numbers, can be verified, for instance, by contacting the user 101 via these addresses or phone numbers, whereby the user 101 responds to the contact in a specific way so that the service provider considers the verification as having been successful.

In order to identify users 101 in the intermediary agency 104, user identifiers are stored in the user database 107 for the registered users. These user identifiers are entered by the users 101 in response to a prompt by the intermediary agency 104, for example, on a website that has been provided by the intermediary agency 104. The user identifier used for the identification can be a data element of the user data that was acquired during the secure process, for example, the name of the user. However, it is an identifier that has been indicated by the user 101 in question or that has been prescribed by the intermediary agency and that is stored in the user database 107 as additional information for purposes of identifying the user vis-à-vis the intermediary agency 104.

To provide users 101 with a secure access to the intermediary agency 104, the intermediary agency 104 is also able to authenticate the users 101 who are registered in the user database 107. This is done on the basis of authentication information of the users 101 that can have been stored together with the user data in the user database 107. The authentication information for a user 101 can comprise, for example, a user identifier and an associated secret password that, for authentication purposes, the user 101 enters on a website provided by the intermediary agency 104 or in some other manner, or it can be a digital certificate for checking a digital signature that the user 101 transmits to the intermediary agency 104 for authentication purposes. By the same token, the authentication information can be, for instance, data for checking a biometric feature of the user 101, for example, a fingerprint, an iris pattern or a voice profile, whereby the biometric feature for the user authentication can be captured by the user computer 106 and transmitted to the intermediary agency 104 for verification purposes.

By the same token, user data of users 101 can also be employed to authenticate them in the intermediary agency 104, for example, for authentication by a mobile TAN method as is shown schematically in FIG. 2.

In order to authenticate a user 101 on the basis of the mobile TAN method, the intermediary agency 104 generates a transaction number (TAN) and transmits a message containing the transaction number to a mobile terminal device 201 of the user 101 (Steps 203a, 203b). The transmission of the message involves a phone number that is associated with the mobile terminal device 201 and that is stored as a constituent of the data of the user 101 in the user database 107. The TAN is an alphanumeric character string that is used once (i.e. for precisely one authentication procedure) and that is generated randomly, by the intermediary agency 104. The message containing the TAN can be transmitted to the mobile terminal device 201 of the user 101, for example, via a cellular network 202, in the form of an SMS (Short Message Service) or by some other message transmission service provided by the cellular network 202.

After the message has been received, the user 101 enters (Step 205) the TAN on a website provided for this purpose by the intermediary agency 104, and the entered TAN is transmitted to the intermediary agency 104. In the embodiment shown in FIG. 2, the user 101 accesses the website using user computer 106. After the message has been received, the TAN is displayed on the mobile terminal device 201 and, in order to enter this TAN on the website, the user 101 reads off (Step 204) the TAN from the mobile terminal device 201 and then enters it on the website using the user computer 106.

After the TAN entered by the user 101 has been transmitted to the intermediary agency 104, the intermediary agency 104 compares the entered TAN to the TAN that was previously transmitted to the mobile terminal device 201 of the user 101 and that is stored in the intermediary agency 104 for this purpose. If these two TANs match, then the user authentication is completed successfully. If the two TANs differ, then the user authentication is considered to have failed. In case of a failure, the mobile TAN method can be repeated with a new TAN, for example, so that a user 101 who inadvertently entered an incorrect TAN on the website can be given the opportunity to obtain a successful authentication after the repeated attempt.

In order to generate a user account for access to the service provided by the service server 102 via the intermediary agency 104, the user 101 requests the set-up of the user account at the intermediary agency 104. For this purpose, the intermediary agency 104 employs the web platform it has provided to give the user the possibility to select the service server 102 or the desired service provided by the service server 102 from among the services registered in the service database 105. For this purpose, one or more websites of the web platform can be provided on which the registered services are displayed together with the description stored for the services. As an alternative or in addition, the user can be given the possibility to directly specify the service on a website of the web platform, for example, on the basis of an appropriate designation. In this manner, the user 101 can request the opening of a user account with a service if the service is registered in the intermediary agency 104. He can receive information to this effect, for instance, from the service server 102 or from the service provider.

Once the user 101 has selected or specified a service, the intermediary agency 104 generates the user account on the basis of the interaction with the user 101 and with the service server 102. In one embodiment, the generation of the user account involves the identification and the authentication of the user 101 in the intermediary agency 104, as well as the approval of the opening of the user account by the user 101. The approval can be given by the user in a separate step by a user action that is taken, for example, on a website provided by the intermediary agency 104. In another embodiment, the approval is given implicitly when the user 101 enters the identification and/or authentication information.

In one embodiment, in order to identify the user, in a response to the request that a user account be generated for the selected service, the intermediary agency 104 prompts the user 101 to indicate the user identifier that is stored in the user database 107 for the user 101. The request is contained in a website that is provided by the intermediary agency 104 and that offers the user 101 the ability to enter the requested user identifier. This can be done on the basis of an appropriate input field for entering of the user identifier on the website, whereby the entered user identifier is transmitted to the intermediary agency 104 on the basis of a user action, for example, and the actuation of a button.

In one embodiment, a two-stage authentication procedure is provided in order to authenticate the user 101 in the intermediary agency 104. Here, together with the prompt to indicate the user identifier, the user 101 is prompted to transmit authentication data for a first user authentication. This authentication data can be the secret password of the user 101 that is stored in the user database 107. The password can be entered in another input field on the same website, together with the entry of the user identifier, whereby the transmission of the authentication data on the basis of a user action to this effect is carried out in the same step as the transmission of the user identifier. After the checking of the authentication data has been successful, the user 101 reaches a first authentication level in case of a two-stage authentication procedure.

After the transition to the first authentication level, if applicable, the intermediary agency 104 carries out a further authentication of the user 101 in the second stage. The user authentication in the second stage is carried out in a different manner than in the first stage; more specifically, different authentication data is used than in the first authentication stage. The user authentication in the second stage is a process that involves another data exchange between the user 101 and the intermediary agency 104. Depending on the type of the specified user authentication in the second stage, the communication takes place via additional websites that are provided by the intermediary agency 104 and/or on the basis of messages that are exchanged between the user computer 106 and intermediary agency 104. In one embodiment, the user authentication in the second stage is carried out by the above-mentioned mobile TAN method. As an alternative, the user authentication of the second stage can also be carried out in a different manner, for example, by checking a biometric feature of the user such as, for instance, a fingerprint, the iris pattern or a voice profile of the user 101, which is captured by the user computer 106 and sent to the intermediary agency 104 to be verified.

In another embodiment, a one-stage user authentication procedure is carried out in the intermediary agency 104 and a second stage is dispensed with. Moreover, one embodiment provides that the number of stages for the user authentication is selected as a function of the service that the user 101 would like to access. In this context, it can be indicated for the services that are registered in the service database 105 in the intermediary agency 104 whether a one-stage or a two-stage user authentication procedure is to be carried out in the intermediary agency 104 in order to generate a user account for access to the service. This information can be prescribed by the individual service providers. A merely one-stage user authentication procedure simplifies the authentication procedure for the user and thus enhances the convenience for users. A two-stage authentication procedure can be selected if a higher level of security is required, for example, if the use of the service is fee-based and if the user agrees with the opening of the user account in order to pay for the service.

After the successful identification and authentication of the user 101 in the intermediary agency 104, the latter initiates the opening of a user account on the basis of an interaction with the service server 102. In particular, a request to open a user account is sent by the intermediary agency 104 to the service server 102. In one embodiment, together with the request, user identification data is transmitted by the intermediary agency 104 to the service server 102. In response to the request of the intermediary agency 104, the service server 102 generates a user account for the user in the user database 103 and stores in the user account the user identification data that was received together with the request.

In one embodiment, additional data of the user is not stored in the user database 103. In this embodiment, the information that the service server 102 receives about the user is limited to the user identification data provided by the intermediary agency 104. As will be shown below, the user identification data does not contain any personal information about the user, so that the user can use the service anonymously. However, the operator of the intermediary agency 104 provides personal information to the service provider in response to a well-founded request, for example, if the service provider has a legitimate interest in receiving the personal information. This can be the case, for example, if the user fails to pay for a fee-based service.

In one embodiment, the user identification data includes a user identifier that is unambiguously associated with the user 101 by the intermediary agency 104 and that can be generated in the intermediary agency 104. For example, this can be an alphanumeric character string that is generated in a suitable manner in the intermediary agency 104. In an alternative embodiment, the user identification data is entered by the user 101 in response to a request by the intermediary agency 104. In order for the user identifier to be entered, the intermediary agency 104 can provide, for instance, a website containing an input field into which the user 101 enters a user identifier. When the user 101 enters the user identifier, the intermediary agency 104 ensures that the user identifier can be unambiguously associated with the user account that is to be opened. For this purpose, the intermediary agency 104 checks whether an identical user identifier is already being used for another user account. If this is the case, the intermediary agency 104 prompts the user 101 to change the user identifier he has entered. Here, the intermediary agency 104 can also make a proposal for an unambiguous user identifier.

On the basis of the transmission of the user identifier to the intermediary agency 104, the intermediary agency 104 stores the user identifier, indicating the service server 102 or the service, in the user data that is stored in the user database 107 of the intermediary agency 104. In this manner, the user is also registered for the service in the intermediary agency 104. The user identifier can be viewed as an unambiguous identifier of the relationship between the user 101 and the service server 102 that is established on the basis of the opening of the user account. On the basis of the user identifier, an anonymous user account can be set up for the user 101 in the service server 102, whereby the contractual relationship between the service provider and the user 101 is secured by the intermediary agency 104.

Optionally, in response to a prompt from the intermediary agency 104 to this effect, the user 101 can specify an additional authentication feature that the intermediary agency 104 stores in the user account at the time when the user account is opened. The authentication feature matches an authentication feature that is stored in the user account, also in case of the direct registration of a user in the service server 102, and that, as already described above, can be a secret password of the user. In one embodiment, the authentication feature can be employed by the user 101, together with the user identifier, to directly log in to the service server 102 after the user account has been opened via the intermediary agency 104.

After a user account has been opened via the intermediary agency 104, the user account can be deleted again via the intermediary agency 104. In one embodiment, this is done upon request by the user 101. The request can be entered by the user 101 on a website provided by the intermediary agency 104. The user account is deleted after a successful authentication of the user 101 in the intermediary agency 104, said authentication being performed in response to the request of the user 101. The authentication can be carried out in a one-stage or a two-stage procedure. In response to the request, the user identifier linked to the service server 102 or the service it provides is deleted from the user data in the user database 107 of the intermediary agency 104 or else it is tagged with a deletion marker. Furthermore, the service server 102 is informed about the deletion request made by the user 101. On the basis of this information, the service server 102 then deletes the user account of the user 101.

In another embodiment, the deletion of the user account can be automatically carried out by the intermediary agency 104 at a prescribed point in time. The point in time can already be indicated by the user 101, for instance, at the time when the user account is opened via the intermediary agency 104 or else at a later point in time. Here, the deletion point in time can be, for instance, the end of a prescribed contract duration for the use of the service provided by the service server 102. Also in the case of an automatic deletion, the user identifier linked to the service server 102 or to the service it provides is deleted from the user data in the user database 107 of the intermediary agency 104 or else it is tagged with a deletion marker. Furthermore, the service server 102 is informed of the deletion request so that the user account can be deleted in the service server 102.

Various embodiments can be used so that the user 101 can log in to the service server 102. One embodiment provides for a log-in of the user to the service server 102. Here, after the user account has been opened via the intermediary agency 104, in response to a prompt by the service server 102 that is made, for instance, on a website provided by the service server 102 and opened by the user 101, the user 101 indicates the user identifier as well as the authentication feature that are stored in the user account. The service server 102 compares the indicated user identifier to the user identifier that is stored in the user account, and the service server 102 also compares the authentication feature entered by the user 101 to the authentication feature that is stored in the user account. If the entries match the stored data, then, in one embodiment, the service server 102 provides access to the provided service that is linked to the user account. In another embodiment, the service server 102 also makes a request to this effect to the intermediary agency 104 in order to check whether the user 101 is registered in the intermediary agency 104 to use the service provided by the service server 102. In this case, access to the service is granted by the service server 102 only if this has been confirmed by the intermediary agency 104.

In another embodiment, after the user account has been opened in the service server 102 via the intermediary agency 104, the user 101 accesses the service server 102. In this embodiment, as already described above, the user 101 first logs in to the intermediary agency 104 and indicates on a website provided by the intermediary agency that he would like to access the service server 102. The log-in takes place on the basis of an identification and authentication of the user 101 in the intermediary agency 104, whereby the user authentication takes place in a one-stage procedure. After the successful identification and authentication of the user 101, the intermediary agency 104 redirects the user 101 to a website provided by the service server 102 via which the user 101 can access the service provided by the service server 102. The redirection can be done in a way that is generally known to the person skilled in the art on the basis of a so-called link that contains a web address of the website of the service server 102 and that is opened by the user on a website of the intermediary agency 104. The website of the service server 102 or its web address is stored in the service database 105 of the intermediary agency 104 in association with the service server 102 or the service provided by the service server 102.

On the basis of the redirection of the user to the service server 102, the intermediary agency 104 sends to the service server 102 the user identifier that had been stored in the service server 102 when the user account was opened. Here, in one embodiment, the user identifier can be contained as a parameter in the web address of the website to which the intermediary agency 104 redirects the user. In particular, the user identifier can be contained as a parameter in a so-called query string of the web address that is transferred from the web browser of the user 101 to the service server 102 when the website specified by the web address is opened. As an alternative, the user identifier can also be sent in a separate message from the intermediary agency 104 to the service server 102. On the basis of the user identifier, the service server 102 identifies the user 101 and, under his user account, grants him access to the service provided by the service server 102. Together with the user identifier, an authentication feature of the intermediary agency 104 such as, for example, a digital signature, is transmitted by the intermediary agency 104 to the service server 102 and this digital signature is checked by the service server 102. In this manner, the authenticity of the user identifier can be ensured. The entry of another authentication feature by the user such as, for example, the entry of the secret password, is not used in this embodiment, but it can, of course, be added.

In another embodiment, the user 101 logs in on a website provided by the service server 102, in order to access the service provided by the service server 102. During this log-in, the user 101 enters the user identifier that had previously been stored by the intermediary agency 104 in the user account of the user 101 in the service server 102. The entry of the user identifier can be made via an appropriate input field of the website provided by the service server 102. In addition, it can be provided that the user indicates the authentication feature and this is checked by the service server 102 so that the log-in to the service server 102 initially takes place in the same manner as already described above. After the user has entered the user identifier and, if applicable, after the authentication feature of the user has been checked, the service server 102 transmits the user identifier to the intermediary agency 104 for verification. Together with the user identifier, identification and authentication information of the service server 102 is sent to the intermediary agency 104 and this information is then used by the intermediary agency 104 for the identification and authentication of the service server 102. After the successful identification and authentication of the service server 102, the intermediary agency 104 checks whether the user 101 is registered under the received user identifier for access to the service provided by the service server 102. If this is the case, the intermediary agency 104 sends a confirmation message to the service server 102. In response to receiving this confirmation message, the service server 102 then grants the user 101 access to the service. The confirmation message contains an authentication feature of the intermediary agency 104, for example, a digital signature that is checked by the service server 102, whereby the access is not granted unless the checking of the authentication feature was successful. On the basis of the confirmation message, the service server 102 can see that the user is (still) registered in the intermediary agency 104 for using the service.

In the embodiment described above, it can also be provided that the user 101 is authenticated by the intermediary agency 104, after the intermediary agency 104 has received the user identifier from the service server 102. This is advantageous in cases when the service server 102 does not carry out an authentication of the user on the basis of an authentication feature. The authentication of the user in the intermediary agency is carried out in a one-stage or two-stage procedure in the manner already described above. In case a user authentication is to be carried out in the intermediary agency 104, the confirmation message sent by the intermediary agency 104 to the service server 102 additionally includes information about the result of the authentication. The service server 102 grants access to the service depending on the result of the authentication contained in the confirmation message. Access is granted after a successful authentication of the user.

If the use of the service provided by the service server 102 by the user 101 is associated with the payment of fees, then the payment of the fees can be handled via the intermediary agency 104. In case of regularly recurring costs such as, for instance, basic fees paid regularly at prescribed invoicing intervals, the invoicing can be carried out automatically by the intermediary agency 104. For this purpose, the amount of the fees and the points in time of the invoicing can be stored in the service database 105 of the intermediary agency 104. At the time when the user account was set up, the user 101 can already have given permission to the intermediary agency to carry out the invoicing.

If a fee is incurred for a certain user action when the service is used via the web platform of the service server 102, this fee can likewise be invoiced via the intermediary agency 104. As a result, the user 101 does not provide the data for the invoicing, for example, bank data, to the service server 102. In one embodiment, in order to make the payment, the user 101 is redirected by the service server 102 to the intermediary agency 104. In one embodiment, the redirection is carried out in that a link is provided to a website that is made available by the service server 102 and that can be opened by the user 101. The link takes the user 101 to a certain website of the intermediary agency 104 in order to make the payment.

In conjunction with the redirection, the user identifier associated with the user 101 is transferred by the service server 102 to the intermediary agency 104. On the basis of the user identifier, the intermediary agency 104 identifies the user for whom the payment is being made. Furthermore, the amount to be invoiced is transferred by the service server 102 to the intermediary agency 104. Together with this information, identification and authentication information of the service server 102 is sent to the intermediary agency 104, which then uses this information to identity and authenticate the service server 102. Here, the payment is not made by the intermediary agency until the successful identification and authentication of the service server 102.

The transfer of the above-mentioned information by the service server 102 to the intermediary agency 104 can be done, for example, in that the data is inserted as a parameter into the web address contained in the link. In particular, as already explained above, the information can be contained in a query string of the web address that is transferred to the intermediary agency 104 when the website is opened. As an alternative, however, this information can likewise be transmitted in a separate message from the service server 102 to the intermediary agency 104.

After the user has been redirected to the intermediary agency 104 and after the service server 102 has been successfully identified and authenticated, the intermediary agency 104 carries out a user authentication. In one embodiment, a two-stage authentication procedure is carried out in the above-mentioned manner. However, it is also possible that only a one-stage user authentication procedure is used. Moreover, it can be provided for the number of stages to be specified by the service server 102. This specification, together with the user identifier and the information about the amount to be invoiced, can be transmitted by the service server 102 to the intermediary agency 104, whereby the intermediary agency 104 recognizes the specification and carries out the user authentication in accordance with the specification. After the successful authentication of the user and, if applicable, after permission has been given by the user for the payment to be made, the payment is made by the intermediary agency 104. This is done by an online payment transaction generally known to the person skilled in the art, for example, with the credit card of the user 101, whose data is captured by the intermediary agency 104 for this purpose, or else this data for the user 101 has already been stored in the user database 107.

After the payment has been made successfully, the user is redirected by the intermediary agency 104 to the service server 102 to continue to use the service of the service server 102. The redirection takes the user to a website whose web address had previously been transmitted as a parameter by the service server 102, or else this web address is permanently stored for the service server 102 in the service database 105 of the intermediary agency 104. For the redirection, in turn, the intermediary agency 104 provides a link containing the web address that is then opened by the user 101 by web browser in order to return to the service server 102. In conjunction with the redirection, the intermediary agency 104 also transmits a confirmation to the service server 102 about the payment. The confirmation can, in turn, be inserted as a parameter into the web address used for the redirection, or else it can be sent as a separate message. Moreover, this confirmation is again associated with an authentication feature that can be checked in the service server 102.

On the basis of the payment being made, the invoicing of the amount due for use of the service is handled between the intermediary agency 104 or its operator and the service provider, and this amount is transferred to the service provider by the operator in a suitable manner that is generally known to the person skilled in the art. Consequently, the intermediary agency 104 also functions as an operator of a payment service for the service provider. In this manner, it is avoided that payment data such as, for example, credit card and/or account data of the user 101 be transferred to the service server 102.

Although described in detail in the drawings and in the presentation above, the presentations are merely illustrative and are provided by way of an example, but should not be construed in a limiting manner. In particular, the subject innovation is not restricted to the elucidated embodiments. The person skilled in the art can glean additional variants of the subject innovation and its execution from the preceding disclosure, from the figures and from the patent claims.

In the patent claims, terms such as “encompass”, “comprise”, “contain”, “have” and the like do not exclude additional elements or steps. The use of the indefinite article does not preclude the plural. Each individual device can execute the functions of several of the units or devices cited in the patent claims. The reference numerals indicated in the patent claims are not to be construed as a limitation of the means and steps employed.

1-15. (canceled)

16. A method comprising:
providing user identification data in order to generate a user account containing user identification data in a service server that provides an electronic service;
making use of the user account, whereby a user is registered with personal data in an intermediary agency and, on the basis of registration of the user, the intermediary agency transmits to the service server the user identification data as well as a request for generation of the user account, wherein the service server generates the user account; and
making use of the user identification data, whereby the user identification data that is transferred from the intermediary agency to the service server does not contain the personal data, and whereby the intermediary agency makes a payment on behalf of the user in response to having received a payment request from the service server.

17. The method according to claim 16, whereby the user identification data comprises a user identifier generated autonomously by the intermediary agency and/or a user identifier indicated by the user.

18. The method according to claim 16, whereby the user identification data comprises an authentication feature indicated by the user, the authentication feature comprising a secret password.

19. The method according to claim 16, whereby, after the user account has been generated, the electronic service is accessed on the basis of the user identification data.

20. The method according to claim 19, whereby the user identification data is transmitted by the user, using the user account, to the service server so that the service can be accessed.

21. The method according to claim 20, whereby the service server compares the transmitted user identification data to user identification data stored in the user account and, after a successful comparison, the service server allows access to the electronic service.

22. The method according to claim 20, whereby the service server transmits to the intermediary agency the transmitted user identification data so that it can be checked, and the service server grants the user access to the electronic service based on having received a confirmation message from the intermediary agency about a successful checking of the user identification data.

23. The method according to claim 19, whereby the user identification data is transmitted by the intermediary agency to the service server in response to a request by the user so that the electronic service can be accessed.

24. The method according to claim 23, whereby the intermediary agency provides a website where the request can be made.

25. The method according to claim 23, whereby the user identification data is transmitted to the service server together with an authentication feature of the intermediary agency, whereby the service server grants access to the electronic service after checking of the authentication feature has been successful.

26. The method according to claim 16, whereby the intermediary agency carries out an authentication of the user, and the user identification data is not transmitted to the service server until after the authentication of the user is successful.

27. The method according claim 16, whereby the intermediary agency makes a payment on behalf of the user in response to having received a payment request from the service server.

28. The method according to claim 16, whereby, in order to make the payment, the user is redirected from the service server to the intermediary agency.

29. A computer-readable storage media comprising instructions that cause a processor unit of the intermediary agency to:
provide user identification data in order to generate a user account containing user identification data in a service server that provides an electronic service;
make use of the user account, whereby a user is registered with personal data in an intermediary agency and, on the basis of registration of the user, the intermediary agency transmits to the service server the user identification data as well as a request for generation of the user account, wherein the service server generates the user account; and
make use of the user identification data, whereby the user identification data that is transferred from the intermediary agency to the service server does not contain the personal data, and whereby the intermediary agency makes a payment on behalf of the user in response to having received a payment request from the service server, whereby the user identification data is transmitted by the intermediary agency to the service server in response to a request by the user so that the electronic service can be accessed.

30. An intermediary agency for providing user identification data in order to generate a user account containing user identification data in a service server that provides an electronic service, making use of a user account, whereby the intermediary agency comprises:
a user database in which user data containing personal data acquired in a secure process is stored; and
a service database with registered services provided by service servers, and whereby, based on a registration of a user, the intermediary agency transmits to the service server the user identification data as well as a request for generation of the user account, wherein the service server generates the user account by making use of the user identification data, whereby the user identification data does not contain the personal data in the intermediary agency.
